(19) United States
(12) Patent Application Publication
(10) Pub. No.: US 2006/0001841 A1
(43) Pub. Date: Jan. 5, 2006

(54) Internal device projector if images on polymedrons with polarizable

(76) Inventor: Alfredo Gonzalez Colunga, Oviedo (ES)

Correspondence Address: ROBERT PLATT BELL, P.O. BOX 310, AURORA, NY, 13026, US

(21) Appl. No.: 10/520,283

(22) PCT Filed: Jul. 30, 2003
(86) PCT No.: PCT/ES03/00396

§ 371 Date: Jan. 31, 2005

(30) Foreign Application Priority Data
Jul. 13, 2002 (ES) P200201868

(51) Int. Cl. G03B 21/26

(52) U.S. Cl. 353/94

(57) ABSTRACT

INTERNAL DEVICE PROJECTOR OF IMAGES ON POLYHEDRONS WITH POLARIZABLE GLASS FACES AND PROJECTION PROCEDURE consisting the device of several hollow polyhedrons contained between them with faces of translucent glass polarizable by electrical current that transform them to transparent, with an apparatus projector of images in the interior of the smaller polyhedron and a system of lens or mirrors that directs to all the polyhedron faces the image emitted from the inside which is formed by retro projection in the translucent faces and stops projecting on them when they become transparent projecting on the next polyhedron in a translucent state and a procedure of projection of images from the inside on the polarizable glass faces of a succession of polyhedrons contained between them that operates as a screen when they are translucent and projects the image on the next translucent polyhedron when they become transparent.

### BACKGROUND TO THE PREVIOUS TECHNICAL SITUATION

It is unknown so far in the background to the previous technical situation a device with a projector of images situated in the inner part of the smaller polyhedron of two or more hollow polyhedrons which are contained one another being inscribed but not conjugated or encapsulated with contact faces, since it is essential that there is enough distance between their faces so that an external spectator could appreciate the three-dimensional or space effect that is proposed and being the smaller one contained in the bigger that circumscribes it and this one successively in the next, all of them could be either concentric, in that case they would have the same centre, or could be leaned on a same base or each one could have different base in different levels, essentially characterised by beingt fitted each one with faces of translucent glass polarizable to transparent making it possible to project images in a successive way on every polyhedron, the inner one or any of the outer ones when the glass polarization is activated since on becoming transparent it allows to modify the glass screen where the image is projected by retro projection with a three-dimensional effect and with a demonstrative, advertising or exhibition purpose.

### DISCLOSURE OF THE INVENTION

The proposed invention is a retro projection procedure and an appropriate device for its working, based on the retro projection of images on concentric or successive screens which are activated successively in order to fix the image of the projector on every screen since the screens consist of two sheets of glass or another transparent material with a liquid between both sheets which is liable to conversion to transparent or translucent by electric polarization or depolarisation, so that the image stops reflecting on the screen when it is transparent and on the contrary the image is reflected on the one that is in translucent state, producing the effect of moving the space plane where the image it is formed, approaching or moving off from the spectator and increasing or decreasing its size.

As a result the procedure is a system of images retro projection associated to the next technical characteristics:

1°.—The source of images will be placed inside the inner polyhedron of two or more hollow ones preferably regular with the same shape although irregular or with a different shape polyhedrons could be used if they are provided with lens, mirrors or auxiliary projectors of redirection of images situated in those faces of each polyhedron that are not used as screens in order to the auxiliary means are made invisible to the spectator.

2°.—The polyhedrons will be disposed in a way that each one is interior or inscribed in respect of the next one that circumscribes it with separation between its faces so that each polyhedron faces used as screens are parallel total or partially inscribed inside the luminic angle of projection of the images, though in certain cases the inscribed polyhedrons could be conjugated or have their faces in angle in respect of those of the circumscribed polyhedron in which case they will have to be associated to a complex system of lens, mirrors or another optical means which redirect by reflection the images to the next polyhedron or have auxiliary independent projectors, since the essential content of the new invention is the visual effect that is caused to the spectator by a multiscreen device in which each screen inscribed inside another bigger one or circumscribed to another smaller one could become transparent or translucent by modifying the special location of the same image in a three-dimensional system. As far as the present description is concerned, an inscribed polyhedron is defined as the one, which is contained in another bigger one that circumscribes it, similarly to what is said about a polygon inscribed inside a circumscribed polygon.

3°.—The polyhedron faces will be made of a special crystal, in glass, methacrylate or any other substance, characterised by being translucent under ordinary conditions, operating in this case to an external observer as a screen to retro project the images projected on it emitted from the inner part of the polyhedrons, or becoming transparent by polarization or another method when a light electrical current pass through it. In such a case the images that appear from the device projector of images will pass through the transparent glass freely and they will project on the next polyhedron faces that are translucent, directly or by reflection of the image by means of lens or auxiliary mirrors, and they could also be emitted on the circumscribed polyhedron by means of independent auxiliary projectors, being essential that they are seen by an outside observer by retro projection in one or another screen being contained each one in the bigger one, and that the screen where the images are projected could be modified at the choice of an operator or the spectator himself.

4°.—With a device of dynamic effect which modifies the polyhedrons translucent or transparent state by activating or deactivating the glass polarization, like a computer or another system that regulates the electrical current of polarization of each polyhedron glasses, it will be possible to project images from the inside of them, successively on any of the faces of every polyhedron, depending on whether they are polarized or not, and thus each polyhedron could act in an independent way in a three-dimensional multiscreen system.

5°.—An auxiliary system of lens, mirrors or auxiliary independent projectors will have to make sure that the same image emitted by a projector or from an internal bunch of projectors is appropriately directed for its projection or it is projected from an auxiliary projector on each polyhedron faces.

6°.—The internal images projector in every case will remain concealed to the spectator just because there will always be between the spectator and the projector an activated screen with images projected on it that will prevent the projector from being seen. This one could be concealed as the case may require in order to make it disappear from the inner polyhedron in which is contained to make it invisible supposing that the operator polarizes the faces of all the polyhedrons making them totally transparent.

7°.—The lens or auxiliary mirrors of redirection of images and as the case may be the independent auxiliary projectors, will be installed in one of the polyhedrons faces that is not used as a screen, so they stay concealed to the spectator sight on those polyhedrons faces that operate as screens.

The new invented device is a projector located in the inner polyhedron of two or more polyhedral bodies inscribed each one in the bigger one that contains it, concentric or not, provided with preferably parallel faces which are separated between them and inscribed into the emitter angle of projection of light, made of translucent polarizable crystal, either glass, methacrylate or any other material, provided with a system of lens or multidirectional mirrors in order to allow the projection of the same image on all the faces of every glass polyhedron from the inside so that glass polarization and depolarisation allow the image to be seen in any of the glass polyhedrons by modifying its three-dimensional location in space simultaneously in all the polyhedron faces or in those selected as screens without the images projector is accessible to the eye of the spectator since it is located inside and because an activated screen always exists between the spectator and the projector or as the case may require by concealing the projector in order to make it disappear if all screens are polarized and made transparent. In that way a new device of projection with luminic, three-dimensional and dynamic effects, able of holding the spectator attention at high degree with an advertising, didactic or entertainment purpose is obtained.

### INSTRUCTIONS AS TO THE BEST WAY OF BRINGING THE INVENTION INTO EFFECT.

It is proposed as to the best way of bringing the invention into effect the construction of two hollow concentric cubes, with side faces of glass or multilaminar methacrylate provided within its sheets with a liquid polarizable under the action of a low-intensity current that causes its transparency effect by polarization as the one used in any of the notorious patents or trademarks on the market in order to activate the transparency of translucent glass screens.

In the geometrical centre of those polyhedrons the system is provided with a projector or a bunch of images projectors which by means of a set of lens or mirror reflects the same image on every face of the polyhedron where it is contained, being able of making it indifferently in the inner polyhedron if its glass faces are translucent in order to allow that the screen effect of the image is produced in them, or in case that the faces of that inner polyhedron are polarized and made transparent, they could project on those of the outer polyhedron or on the following one that will have been depolarised and transformed to a translucent state with the same purpose, provided that the faces of the polyhedron placed in the middle as the case may be are in transparent state. In that way the same image could be seen in every face of each polyhedron, not only on the outer one but also on any of the inner ones, and so its projection could be alternated dynamically in each polyhedron with the effect of the modification of the three-dimensional location of the images projected on all the faces of each one, without the projector contained in the centre is visible, in order to hold intensely and with a new way the spectator attention with a didactic, advertising or entertainment aim.

The association of the device to a system of sensors (either of a luminic, acoustic or thermal nature) or as the case may require to a computer, allows that a programmed sequence of projections by response to a stimulus as the mere presence of an spectator o any other stimulus that activates the sensors, is activated.

### TECHNICAL FIELD

The described invention has industrial application as projector with a didactic, advertising or entertainment aim.

1.—INTERNAL DEVICE PROJECTOR OF IMAGES ON POLYHEDRONS WITH POLARIZABLE GLASS FACES consisting of a inner projector of images on several screens joint in a polyhedron, essentially characterised by being an apparatus projector or a bunch of projectors located in the inner polyhedron of two or more polyhedral bodies inscribed or contained each one in another bigger that contains it, concentric or not, whose faces are screens separated between them and made of a translucent crystal formed by two sheets of glass, methacrylate or any other multilaminar material with a liquid between them polarizable by an electrical current that make it become transparent or it is made translucent when the electrical current stops. The projectors can be or not associated with a system of multidirectional lens or mirrors or independent auxiliary projectors to allow the projection directly, by reflection or by an auxiliary projection of the same image on all the faces of every glass polyhedron from the inside. The glass polarization and depolarisation allows the spectator to see the image successively in any of the glass polyhedrons contained or inscribed between them combining the transparency state of the faces that are not used as screens of retro projection with the translucent state of those that are used as screens, modifying the three-dimensional location in the space of the image simultaneously in every face of each polyhedron or in those selected as screens without the spectator has accessible sight of the images projector since it is located inside and an activated screen is always between the spectator and the projector or as the case may be the projector is hideable in order to make it disappear if all the screens are polarized and made transparent, obtaining luminic, three-dimensional and dynamic effects able of holding the spectator attention at high-degree with a advertising, didactic or entertainment aim:

2.—INTERNAL DEVICE PROJECTOR OF IMAGES ON POLYHEDRONS WITH POLARIZABLE GLASS FACES according to claim 1 that is essentially characterised by being an apparatus projector or a bunch or projectors located in the inner polyhedron of two or more polyhedral regular bodies in the same way inscribed each one in another bigger that contains it, concentric or not, whose faces are parallel and separated between them remaining inscribed into the emitter angle of projection of light, so that the same image is projected directly on every face of each glass polyhedron from the inside according to the transparent or translucent state of each one.

3.—INTERNAL DEVICE PROJECTOR OF IMAGES ON POLYHEDRONS WITH POLARIZABLE GLASS FACES according to claim 1 that is essentially characterised by being the transparent or translucent state of each polyhedron activable into a sequence by means of a system of luminic, acoustic or thermal sensors which react to a stimulus or external agent, associated or not to a computer able to programme the polarization of each glass by means of an electrical current and to select the images to emit by the projector.

4.—PROJECTOR PROCEDURE to the projection of images by retro projection essentially characterised by consisting of a procedure of combined utilization and of association between a projector and a set of multiple multilaminar screens of glass, methacrylate or any other transparent material with a liquid between the sheets liable to become transparent or translucent by the action of an electrical current. In this projection procedure the source of images will be located inside the inner polyhedron of two or more hollow polyhedrons preferably regular with the same shape though irregular or with different shape polyhedrons could be used if they are provided with lens, mirrors or auxiliary projectors of redirection of images placed in those faces of each polyhedron that are not used as screens in order to make invisible the auxiliary means to the spectator, being the polyhedrons arranged in a way that each one is interior or inscribed in relation to the next one that circumscribes it with separation between its faces. In this way the faces of each polyhedron used as screens will be preferably parallel total or partially inscribed into the luminic angle of projection of the images, though in certain cases the inscribed polyhedrons could be conjugated or have their faces in angle with regard to those of the circumscribed polyhedron and in that case they will have to be associated to a complex system of lens, mirrors or other optical means that redirect the images by reflection to the next polyhedron or to have auxiliary independent projectors. When the passing of the electrical current is activated modifying the screens translucent or transparent state it is produced to the spectator the essential visual effect of modifying the space location of the same image in successive planes of the polyhedrons faces, in a three-dimensional system forming the image in the screen which is in the translucent state or letting the image pass without reflecting on the screens that are in a transparent state. The screens that are in a translucent state perform in such case for an outer observer as screens of retro projection of images emitted on it from the inside of the polyhedrons, but when a light electrical current is made pass through it, they become transparent by polarization or another method. The images that come out of the device projector of images will pass freely through the glass that is in a transparent state and they will be projected on the faces of the next polyhedron that are translucent, directly or by reflection of the image by means of lens or auxiliary mirrors, being also able of being emitted on the faces of the circumscribed polyhedron by means of independent auxiliary projectors, so that they will be seen by an outer observer by retro projection in one or another screen and being contained each one in the bigger one, and the screen in which they are projected could be modified at an operator or the spectator himself choice. The procedure uses an electrical or electronic device of dynamic effect to modify the translucent or transparent state of the polyhedrons by activating or deactivating the screens polarization, as a computer or any other system that regulates the electrical current of polarization of the glasses of each polyhedron, making it possible to project, from their inside, images in a successive way on any of the faces of each polyhedron, depending on if they are polarized or not, so that each polyhedron could act independently within a multiscreen three-dimensional system. The projection can be carried out using an auxiliary system of lens, mirrors or independent auxiliary projectors to make sure that the same image emitted by a projector or a bunch of inner projectors is directed in a suitable way for its projection or it is projected from an auxiliary projector on each polyhedron faces, so that the inner projector of images in each case remains hidden to the spectator by the fact that an activated screen with images projected on it that will prevent the projector sight, will always be between the spectator and the projector. The projector could also be hideable in order to make it disappear from the inner polyhedron where it is contained to make it invisible in the case that the operator polarizes the faces of all the polyhedrons making them totally transparent. As the case may be the lens, the auxiliary mirrors of redirection of the images or the independent auxiliary projectors will be installed in a face of the polyhedrons that is not used as screen, so that they remain hidden to the spectator eyesight of the images projected on those faces of the polyhedrons which are used as screens.
